(19) United States
(12) Patent Application Publication
(10) Pub. No.: US 2003/0061138 A1
(43) Pub. Date: Mar. 27, 2003

(54) Web trading method for reducing stocking costs

(76) Inventors: Cheng-Ju Chen, Taipei (TW); Yi-Ming Liao, Taipei (TW); Kuo-Ching Hong, Taipei (TW); Shu-Mei Chien, Taipei (TW); Shiou-Yu Hung, Taipei (TW); Yun-Chi Lee, Taipei (TW)

Correspondence Address: BIRCH STEWART KOLASCH & BIRCH, PO BOX 747, FALLS CHURCH, VA, 22040-0747, US

(21) Appl. No.: 09/956,965

(22) Filed: Sep. 21, 2001

(51) Int. Cl. G06F 17/60

(52) U.S. Cl. 705/36; 705/37

(57) ABSTRACT

This specification discloses a web trading method for reducing stocking costs. This is achieved mainly by establishing a real-time material supply trading procedure with a materials supplier through a web trading system. The invention includes the following steps. A forecast order containing a material forecast demand is sent from a purchaser to a materials supplier. The materials supplier temporarily stores materials according to the material forecast demand in the storage of the materials supplier. The purchaser can timely send out a real-time demand order containing material real-time demands to the materials supplier according to the production demands to ask the materials supplier to provide the material real-time demands accordingly. At the moment, the materials supplier retrieves the real-time material quantities required in the real-time demand order from its storage and sends them to the purchaser. After the materials being verified by the purchaser, a material payment action is made by the purchaser. Through this material purchasing procedure, some materials stocking costs on the purchaser are transferred to the materials supplier, thus lowering the costs on the purchaser for storing materials.

### BACKGROUND OF THE INVENTION

1. Field of Invention

The invention relates to a business method for implementing trades through a network. in particular, it relates to a material trading method that can lower the materials stocking costs on the purchaser.

2. Related Art

For most manufacturers, there are several methods to increase the gains. Cost management is one of them. Among all kinds of costs, material cost management receives the most attention. To satisfy the product demands from clients, end users or customers, the manufacturer has to properly prepare sufficient materials in order to maintain normal capacity. Maintaining too little materials stocking may cause the company to lose potential business chances, resulting in unbalanced market demands and supplies or losses in market occupancy. On the other hand, preparing too much materials stocking induces accumulation in capitals, difficulty in financial arrangement and increases in management costs. Moreover, the risks due to the market variations may even cause losses in marginal gains.

Existing inventory control techniques, such as the U.S. Pat. No. 6,078,900 entitled “Method for estimating stock levels in production-distribution networks with inventory control” and the U.S. Pat. No. 6,205,431 entitled “System and method for forecasting intermittent demand,” had proposed techniques for inventory management. However, these techniques mainly forecast or determine an optimal stocking amount of materials through collections and calculations of many variables or information. Thus, these methods are complicated in practice.

### SUMMARY OF THE INVENTION

An objective of the invention is to lower the costs for materials stocking. The objective is achieved by transferring the materials stocking costs to materials suppliers.

More explicitly, the disclosed method is as follows: A purchaser first sends a forecast order containing forecast material demand quantities to a materials supplier. The materials supplier then stores the materials according to the forecast material demand quantities in the forecast order in a storage of the materials supplier. Afterwards, the purchaser can timely send out real-time demand orders containing material real-time demand quantities in accordance with the demand for production to the materials supplier. At the moment, the materials supplier retrieves the materials required in the material real-time demand quantities in the real-time demand order from its storage and ships them to the purchaser. After the materials are verified by the purchaser, a material payment action is made by the purchaser. This method prevents materials from stocking up at the purchaser and transfers the stocking costs for the materials in the forecast order to the materials supplier. This then achieves the goal for lowering the materials stocking costs at the purchaser. This method also makes the retrieval of real-time material required for production easier and faster. Therefore, the invention does not only shorten the stocking time of materials but also decreases the cost in time.

The disclosed method first figures out a forecast order containing forecast information about required materials according to the forecast demands (including consumers' demands, retailers' orders and existing stocking quantities). The forecast order is then sent to a materials supplier through a web trading system. The materials supplier then prepares in advance materials according to the materials forecast demands in the forecast order and temporarily stores them in the materials supplier's storage. The purchaser then produces a real-time demand order containing material real-time demands at appropriate time according to the production demands. The real-time demand order is sent to the materials supplier through the Internet or a web electronic trading system to ask the materials supplier to provide the material real-time demands accordingly. At the moment, the materials supplier retrieves the required materials ordered in the real-time demand order from its storage. After verifying the materials, the purchaser completes the payment through the web electronic trading system again. The above-mentioned objective can be thus achieved.

### BRIEF DESCRIPTION OF THE DRAWINGS

The present invention will become more fully understood from the detailed description given hereinbelow illustration only, and thus are not limitative of the present invention, and wherein:

FIG. 1 shows the system structure of the invention;

FIG. 2 is a flowchart of steps for implementing the disclosed method;

FIG. 3 is a flowchart showing an example of sending the forecast order;

FIG. 4 is a flowchart showing another example of sending the forecast order;

FIG. 5 is a flowchart showing an example of sending the real-time demand order; and

FIG. 6 is a flowchart showing another example of sending the real-time demand order.

### DETAILED DESCRIPTION OF THE INVENTION

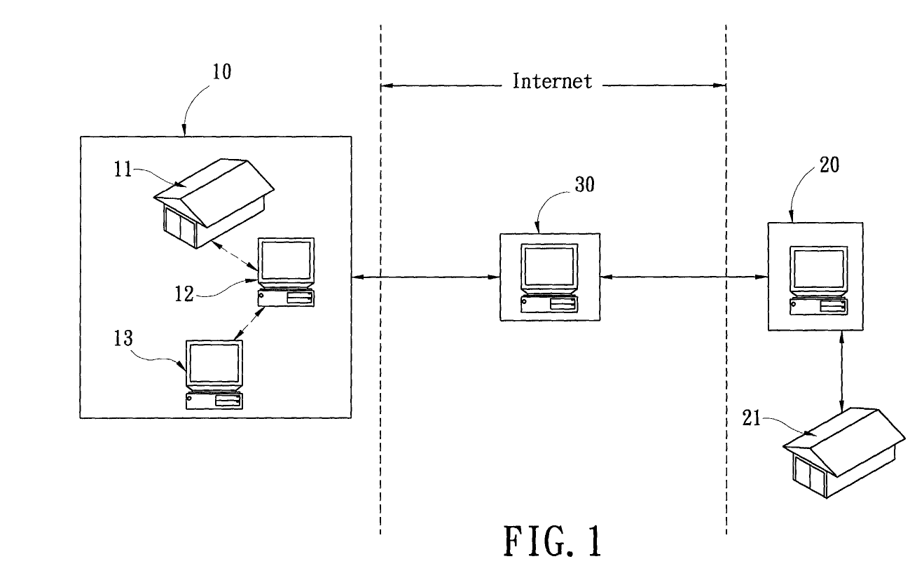

As shown in FIG. 1, a web trading system for implementing the disclosed method includes: a purchaser 10, an inventory management system 12, an order management system 13, a materials supplier 20, and a web trading center 30. The purchaser 10 has a storage 11 for storing materials required by the purchaser 10. The inventory management system 12 records inventory information of the storage 11, such as items and quantities. The order management system 13 stores order information from consumers or retailers. Through MRP (Material Requirements Planning), it generates forecast information containing materials demand forecast according to the material inventory information and order information. The materials demand forecast includes data about required items, quantities, and a timetable. The materials supplier 20 owns a supplier's storage 21. The materials supplier 20 communicates with the purchaser 10 through a network and provides the materials required by the purchaser 10. The web trading center 30 communicates with the purchaser 10 and the material supplier 20 through the network. It is an intermediate processing website between the purchaser 10 and the materials supplier 20. It stores trading information during the web trading process and provides services needed for web trades, such as product commercials, information exchanges and trade security mechanisms.

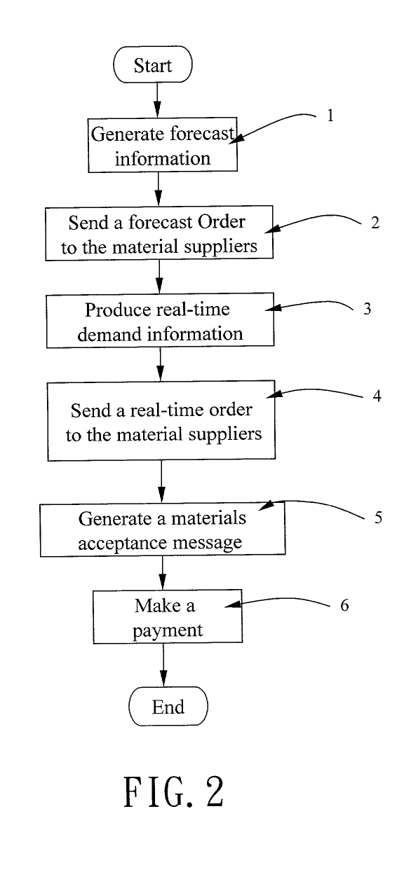

With reference to FIG. 2, the disclosed method includes the following steps:

1. Generate forecast information that contains forecast demands of materials;

2. Send a forecast order containing the forecast information and a return receipt request;

3. Produce real-time demand information, which contains the quantities of the materials required on the assembly lines and these quantities are already included in the above-mentioned materials forecast demands;

4. Send a real-time demand order containing the real-time demand information to the materials supplier;

5. Generate a materials acceptance message after the materials supplier ships the materials required in the real-time demand order to indicate that whether the received materials match with the contents in the real-time demand order; and

6. Make a payment to the materials supplier through a web trading system when the received materials indeed satisfy the requirements in the real-time demand order.

The forecast information generated in step 1 is mainly obtained by considering consumers' demands, retailers' orders and existing stocks. It contains requires items, quantities, and a timetable. Such forecast information is generally produced through MRP (Material Requirements Planning). For example, one can integrate the information in an inventory management system 12 and an order management system 13 in an enterprise intranet, and thereby compute materials forecast demands in a specific period of time according to the consumers' demands and retailers' orders.

The forecast order sent out in step 2 includes the above-mentioned forecast information. The materials information forecasted by the purchaser 10 in a specific period of time is sent to the materials supplier 20 for the materials supplier 20 to prepare the required materials by the time. The material supplier 20 then temporarily stores the materials in its supplier's storage 21. Usually, the prepared materials quantities are some portion of the forecast demand (such as 25% of the demands). The forecast order is not a formal materials order to the materials supplier 20. It can be sent through the following methods:

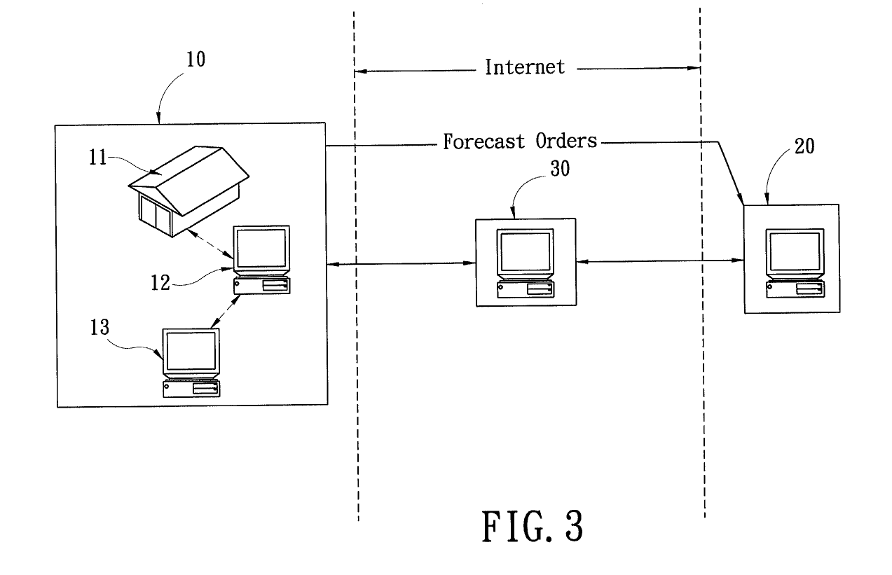

a. The forecast order is sent to a materials supplier 20 through the Internet (FIG. 3);

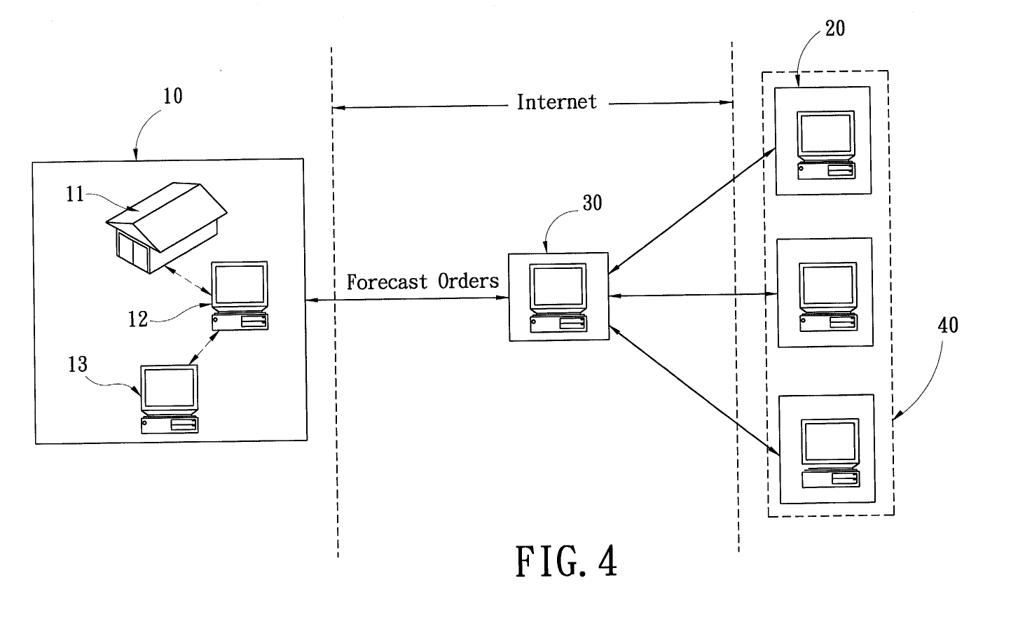

b. The forecast order is sent to a materials supplier group consisting of several materials suppliers 20 through the Internet. For example, the material order 25 can be posted to a web trading center 30 (FIG. 4), through which the order is sent to the materials suppliers.

Another embodiment is to further send a postal order to the materials suppliers 20 for double notifications.

After sending out the forecast order through the above methods, one can further ask the materials supplier 20 to reply with a return receipt.

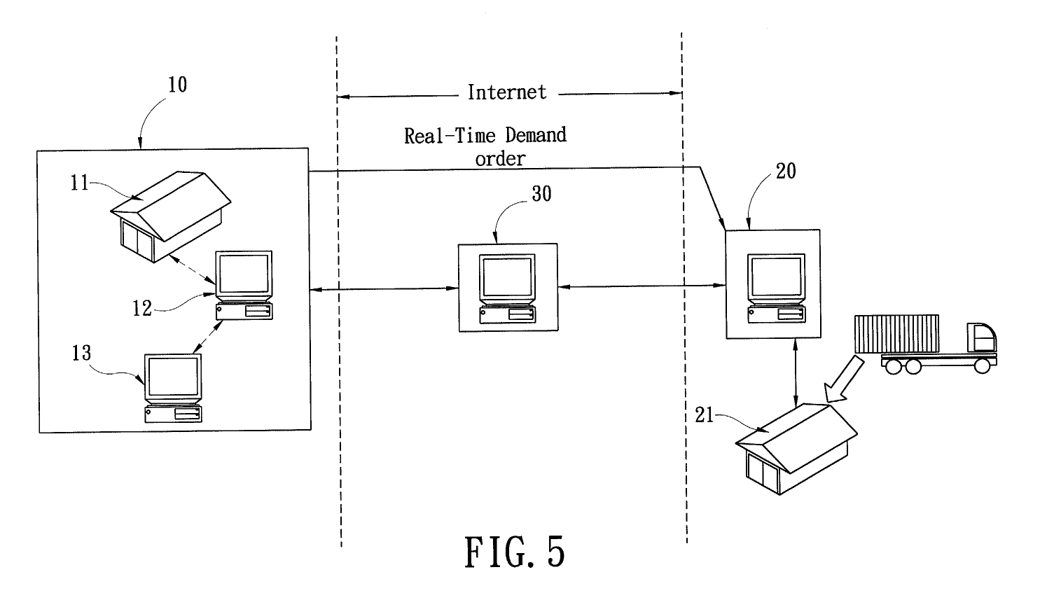

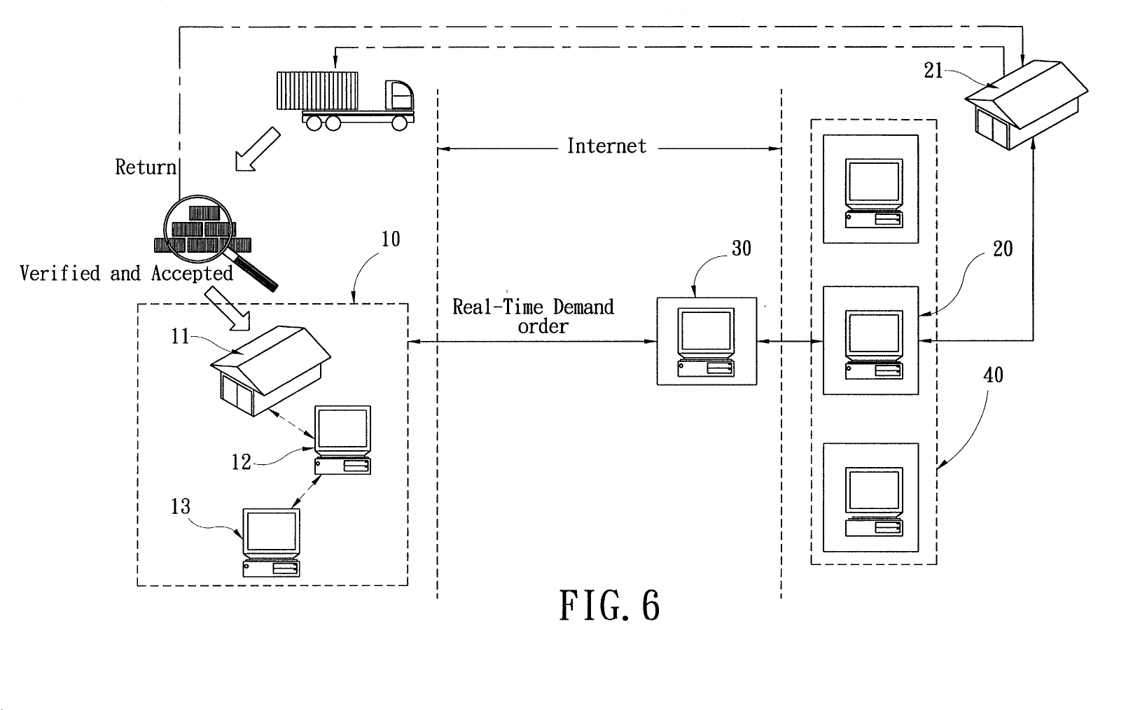

The purpose of steps 3 and 4 is to make a confirmation about the order of the materials requested in the forecast order. The information of materials needed for assembly lines within a few days and already included in the forecast information is made into real-time demand information, which contains material items, quantities, and designated shipping dates that are already provided in the forecast information. Afterwards, as described in step 4, the real-time demand order with the real-time demand information and shipping dates is sent to the confirmed materials supplier 20. The materials supplier 20 then retrieves the materials requested in the real-time demand order with the needed quantities from the supplier's storage 21 and ships them to the purchaser within a short period of time after the materials supplier receives the real-time demand order. The method of sending the real-time demand order is directly through the Internet in order to save time (FIG. 5) or through the electronic trade notification services provided by the web trading center 30 (FIG. 6).

The reason for generating a materials acceptance message in step 5 is to make sure that the shipped materials from the materials supplier 20 are the same as what have been ordered in the real-time demand order. This determines whether a payment should be made in the next step. After the materials supplier 20 retrieves the materials temporarily stored in the supplier's storage 21, the materials are directly shipped to the purchaser 10. The purchaser 10 can perform actual verification through its enterprise Intranet system and generate the materials acceptance message. The materials acceptance message is then added to the order management system 13.

The step of generating a materials acceptance message further includes the step of updating inventory information (step 5-1, as shown in FIG. 2) to add the accepted materials information into the inventory management system 12.

Moreover, the step of generating a materials acceptance message also includes the step of updating the forecast information recorded by the purchaser 10. The forecast information in the system of the purchaser 10 thus subtracts off the information of the accepted materials from its record. The updated forecast information becomes the basis information to generate the next real-time demand information.

Through the above-described method, we can find that the requested materials in the forecast order are not immediately shipped to the purchase 10 after the materials supplier 20 receives the forecast order. Therefore, the purchaser 10 does not have the stocking costs for the forecast material demands. The purchaser 10 only needs to send out a real-time demand order containing the real-time demand information to the already confirmed materials supplier 20 through the Internet in order to rapidly obtain the required materials at a designated shipping date. The payment is made only after the purchaser 10 has verified and accepted the shipped materials. Thus, the purchaser 10 can decrease the stocking costs and control the inventory amount using the disclosed method.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A web trading method for lowering stocking costs for a purchaser to conduct trades of required materials with a materials supplier through a web trading system, which comprises the steps of:
generating forecast information containing materials forecast demands, which are computed according to product order information and current inventory information in a particular period of time and include forecasted material items, quantities and a demand timetable;
sending a forecast order that contains the forecast information to the materials supplier through the Internet for the materials supplier to temporarily store the materials in a materials supplier's storage according to the forecast order;
generating real-time demand information, which includes information about materials that are requested by assembly lines of the purchaser right before productions and have been included in the materials forecast demands;
sending a real-time demand order containing the real-time demand information to the materials supplier;
generating a materials acceptance message, which, after the materials supplier ships the materials, indicates whether the shipped materials are in accordance with the materials requested in the real-time demand order and accepted; and
making a payment to the materials supplier through the web trading system after the materials acceptance message indicates that the received materials are in accordance with the materials requested in the real-time demand order and accepted.

2. The method of claim 1, wherein the forecast information is generated through MRP (Material Requirements Planning).

3. The method of claim 1 further comprising the step of sending the forecast order to the materials supplier by a postal order.

4. The method of claim 1, wherein the forecast order further contains a message asking the materials supplier to reply with a return receipt indicating that the materials supplier can provide the necessary materials supply and identity information of the materials supplier that replies the return receipt is recorded in the forecast order.

5. The method of claim 1, wherein the step of generating a materials acceptance message further comprises the step of updating inventory information to add the verified and accepted materials information into the inventory information.

6. The method of claim 5, wherein the accepted materials information added into the inventory information includes material items and quantities.

7. The method of claim 1, wherein the step of generating a materials acceptance message further comprises the step of updating the forecast information in the forecast order recorded by the purchaser to subtract off the accepted materials from the forecast information.

8. A web trading method for lowering stocking costs for a purchaser to conduct trades of required materials with a materials supplier group consisting of several materials suppliers through a web trading system, which comprises the steps of:
generating forecast information containing materials forecast demands, which are computed according to product order information and current inventory information in a particular period of time and include forecasted material items, quantities and a demand timetable;
posting a forecast order that contains the forecast information to the materials supplier group through the Internet for the materials suppliers to temporarily store the materials in their materials supplier's storages according to the forecast order;
generating real-time demand information, which includes information about materials that are requested by assembly lines of the purchaser right before productions and have been included in the materials forecast demands;
posting a real-time demand order containing the real-time demand information to the materials supplier group;
generating a materials acceptance message, which, after the materials suppliers ship the materials, indicates whether the shipped materials are in accordance with the materials requested in the real-time demand order and accepted; and
making payments to the materials suppliers through the web trading system after the materials acceptance message indicates that the received materials are in accordance with the materials requested in the real-time demand order and accepted.

9. The method of claim 8, wherein the forecast information is generated through MRP (Material Requirements Planning).

10. The method of claim 8 further comprising the step of sending the forecast order to the materials suppliers by a postal order.

11. The method of claim 8, wherein the forecast order further contains a message asking the materials suppliers to reply with a return receipt indicating that the materials suppliers can provide the necessary materials supply and identity information of the materials suppliers that replies the return receipt is recorded in the forecast order.

12. The method of claim 8, wherein the step of generating a materials acceptance message further comprises the step of updating inventory information to add the verified and accepted materials information into the inventory information.

13. The method of claim 12, wherein the accepted materials information added into the inventory information includes material items and quantities.

14. The method of claim 8, wherein the step of generating a materials acceptance message further comprises the step of updating the forecast information in the forecast order recorded by the purchaser to subtract off the accepted materials from the forecast information.
